(19) United States
(12) Patent Application Publication
(10) Pub. No.: US 2009/0222729 A1
(43) Pub. Date: Sep. 3, 2009

(54) Methods and Systems for Audio-Device Activation

(76) Inventor: Sachin G. Deshpande, Vancouver, WA (US)

Correspondence Address: Kristine Elizabeth Matthews, 19302 SE 31st Drive, Camas, WA, 98607, US

(21) Appl. No.: 12/039,976

(22) Filed: Feb. 29, 2008

(51) Int. Cl. G06F 3/048

(52) U.S. Cl. 715/716

(57) ABSTRACT

Aspects of the present invention are related to systems and methods for audio-reproduction device activation in a display mosaic.

### FIELD OF THE INVENTION

Embodiments of the present invention comprise methods and systems for audio device activation in a display mosaic.

### SUMMARY

Embodiments of the present invention comprise methods and systems for activating an audio-reproduction device associated with a display tile in a display mosaic based on a view-port corresponding to an application. A display mosaic may be partitioned into display tiles which may have one or more associated audio-reproduction devices. A display mosaic may display application data for one or more concurrently running applications. A view-port may be associated with each application. Audio related to an application may be directed to audio-reproduction devices associated with display tiles which overlap the application view-port.

Some embodiments of the present invention may comprise a display mosaic system comprising a Scalable Adaptive Graphics Environment (SAGE).

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture showing an exemplary display mosaic comprising non-overlapping display tiles in which neighboring display tiles abut;

FIG. 2 is a picture showing an exemplary display mosaic comprising non-overlapping display tiles and mullions;

FIG. 3 is a picture showing an exemplary application view-port on an exemplary display mosaic;

FIG. 4 is a chart showing exemplary embodiments of the present invention comprising associating display tiles with an application based on the application view-port;

FIG. 5 is a chart showing exemplary embodiments of the present invention comprising playback of application audio on audio-reproduction devices associated with the display tiles associated with the application view-port;

FIG. 6 is a chart showing exemplary embodiments of the present invention comprising audio-reproduction device parameter determination;

FIG. 7 is a chart showing exemplary embodiments of the present invention comprising a Scalable Adaptive Graphics Environment (SAGE);

FIG. 8 is a chart showing exemplary embodiments of the present invention comprising a SAGE and view-port repositioning;

FIG. 9 is a chart showing exemplary embodiments of the present invention comprising a SAGE and view-port resizing;

FIG. 10 is a chart showing exemplary embodiments of the present invention comprising a SAGE and view-port repositioning and resizing;

FIG. 11a is a picture showing an exemplary embodiment of the present invention comprising a display mosaic with audio-reproduction devices embedded in the vertical mullions and an exemplary application view-port;

FIG. 11b is a picture showing the activated audio-reproduction devices in an exemplary embodiment of the present invention for an exemplary application view-port;

FIG. 11c is a picture showing the activated audio-reproduction devices in an exemplary embodiment of the present invention for an exemplary application view-port; and

FIG. 11d is a picture showing the activated audio-reproduction devices in an exemplary embodiment of the present invention for an exemplary view-port.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Some embodiments of the present invention may comprise a display mosaic, also considered an overall display and display wall. In some of these embodiments of the present invention, a display mosaic may comprise multiple, separate displays which may each, or in combination, be considered a display panel, or tile. In alternative embodiments of the present invention, a display mosaic may comprise a physically contiguous, single display, wherein different areas in the physically contiguous, single display may be considered display panels, or tiles. In some of the embodiments comprising a physically contiguous, single display, the display tiles may be non-overlapping. In other of the embodiments comprising a physically contiguous, single display, some, or all, of the display tiles may overlap.

In some embodiments of the present invention, the display tiles of a display mosaic may be located substantially proximate to each other. In alternative embodiments, the display tiles of a display mosaic may be located substantially distant from each other.

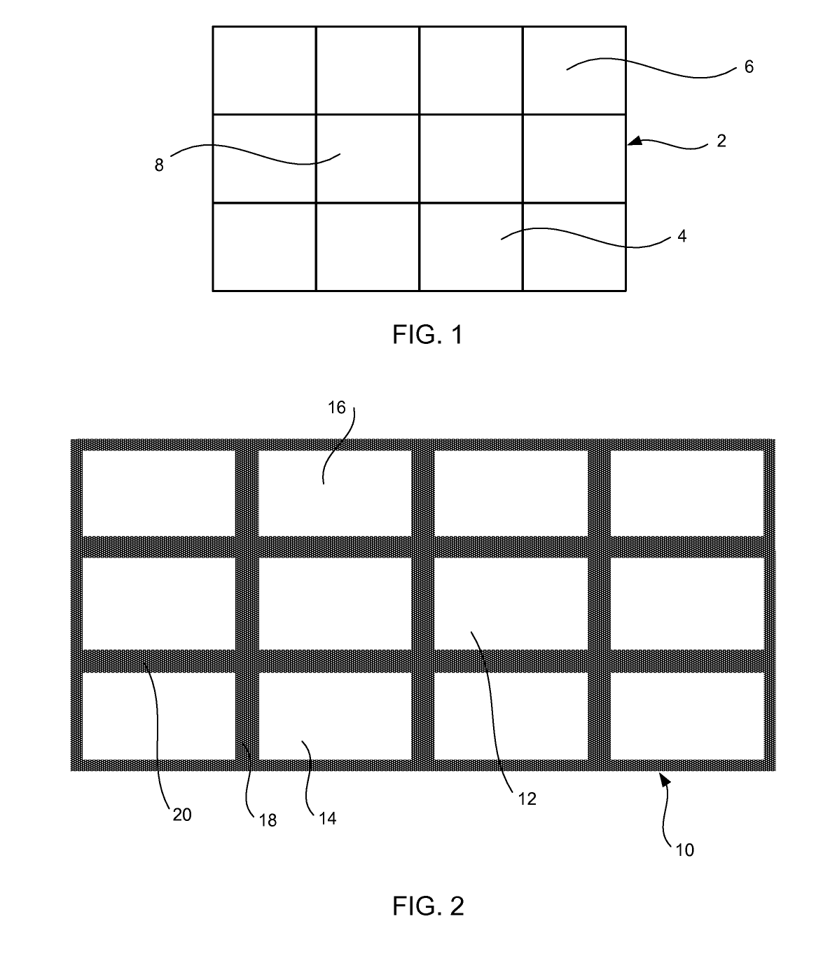

FIG. 1 depicts an exemplary display mosaic 2 comprising twelve, non-overlapping display tiles (three shown labeled 4, 6, 8). The exemplary display mosaic 2 may comprise twelve individual, separate displays wherein neighboring displays directly abut. Alternatively, the exemplary display mosaic 2 may comprise a single, physically-contiguous display 2 which may partitioned into multiple display tiles, wherein, in this example, the partition comprises twelve non-overlapping regions (three shown labeled 4, 6, 8).

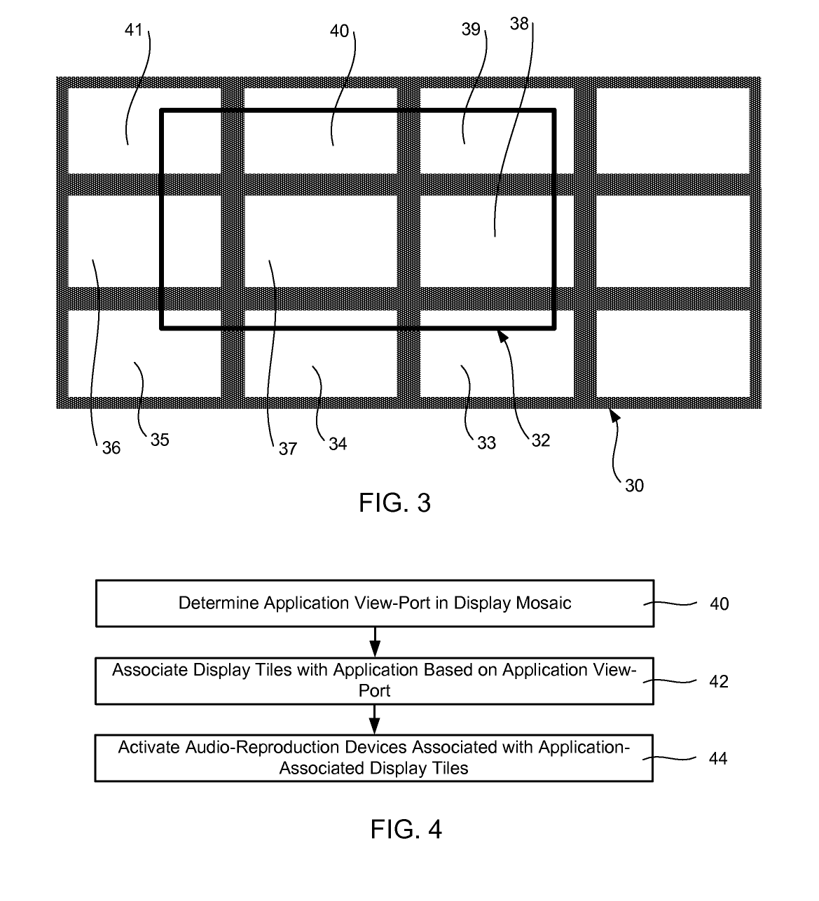

FIG. 2 depicts a second exemplary display mosaic 10 comprising twelve, non-overlapping display tiles (three shown labeled 12, 14, 16). In this exemplary display mosaic 10, the display tiles do not abut, thereby creating a vertical 18 or horizontal 20 spacing between adjacent display tiles. This spacing 18, 20 between adjacent display tiles may be referred to as a mullion.

In some embodiments of the present invention, each display tile in a display mosaic may have one or more associated audio-reproduction devices, also considered audio devices. In alternative embodiments of the present invention, at least one of the display tiles in a display mosaic may not have an associated audio-reproduction device. In an exemplary embodiment in which at least one of the display tiles in a display mosaic does not have an associated audio-reproduction device, only the upper-left display tile, the upper-right display tile, the lower-left display tile and the lower-right display tile have associated audio-reproduction devices. Exemplary audio-reproduction devices may include loudspeakers, digital sound projectors and other audio devices. In some embodiments of the present invention, some, or all, of the audio-reproduction devices associated with a display tile may be attached, embedded or otherwise integral to the display tile. In some embodiments, some, or all, of the audio-reproduction devices associated with a display tile may be separated physically from the display tile. In one exemplary embodiment, an audio-reproduction device associated with a display tile may be concealed behind the display tile. In other exemplary embodiments, some, or all, of the audio-reproduction devices associated with a display tile may be embedded or attached to a border, or mullion, surrounding the display tile.

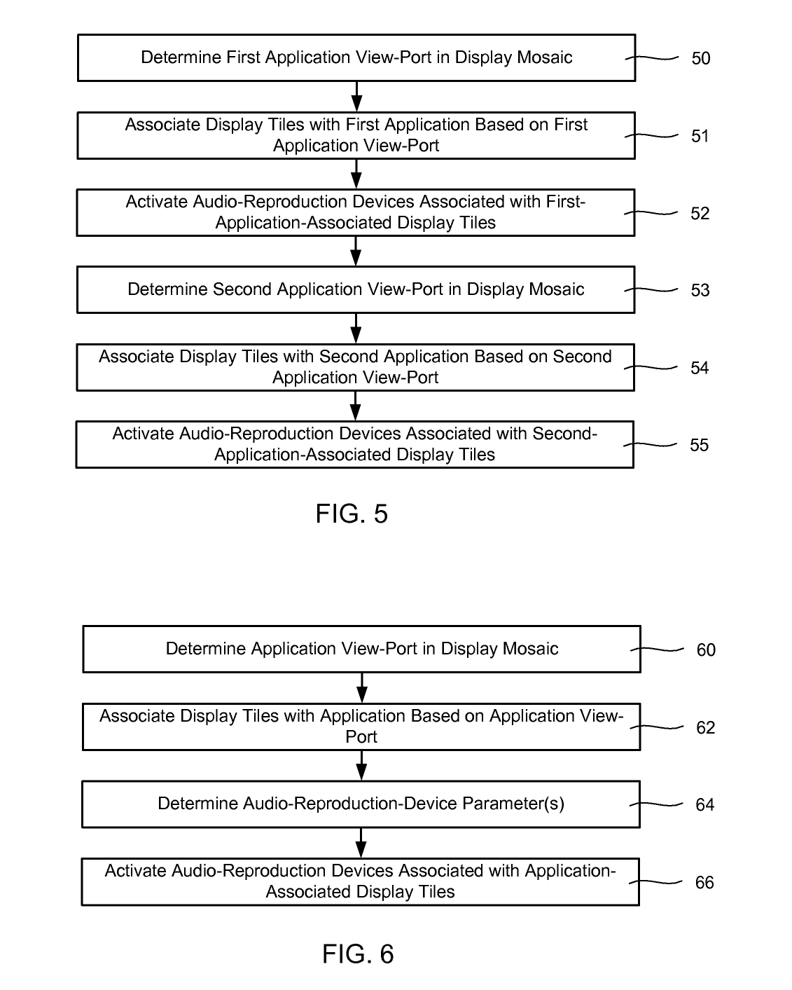

Some embodiments of the present invention may comprise a display mosaic on which application display data associated with an application may be displayed. The application may have an associated view-port, also considered a window, on the display mosaic. The view-port may be considered the area on the display mosaic in which the display data associated with the application is being displayed. This may be understood in relation to FIG. 3 which depicts an exemplary display mosaic 30 comprising twelve, non-overlapping display tiles (nine display tiles shown labeled 33-41). An exemplary application view-port 32 which overlaps nine display tiles 33-41 is shown.

In some embodiments of the present invention, display tiles may be associated with an application based on the application view-port. These display tiles may be referred to as application-associated display tiles. In some of these embodiments, any display tile which overlaps a portion of the application view-port may be associated with the application. For the example shown in FIG. 3, display tiles labeled 33-41 may be associated with the application for such embodiments. In alternative embodiments, the area of the portion of a display tile which overlaps a portion of the application view-port may be compared to a threshold, and when a condition related to the threshold is met, the display tile may be associated with the application. Exemplary thresholds may be based on percentage of area, shape of area, number of display pixels and other display parameters. For example, for the exemplary display mosaic 30 and application view-port 32 shown in FIG. 3, display tile 35 may not be associated with the application, in some embodiments of the present invention, because the display tile 35 does not comprise a significant portion of the application view-port.

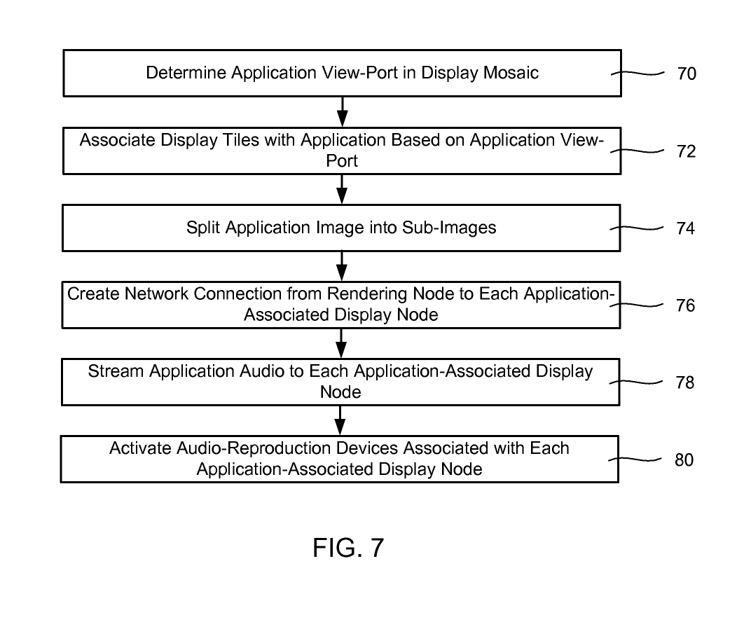

Some embodiments of the present invention may be described in relation to FIG. 4. In these embodiments, an application view-port associated with an application may be determined 40 in a display mosaic. One or more display tiles may be associated 42 with the application based on the application view-port. These tiles may be referred to as application-associated display tiles. The audio-reproduction devices associated with the application-associated display tiles may be activated 44. In some embodiments of the present invention, activation of the audio-reproduction devices associated with the application-associated display tiles may comprise playing of audio content associated with the application, streaming audio content associated with the application to an audio-reproduction device, powering on an audio-reproduction device and other device-activation procedures.

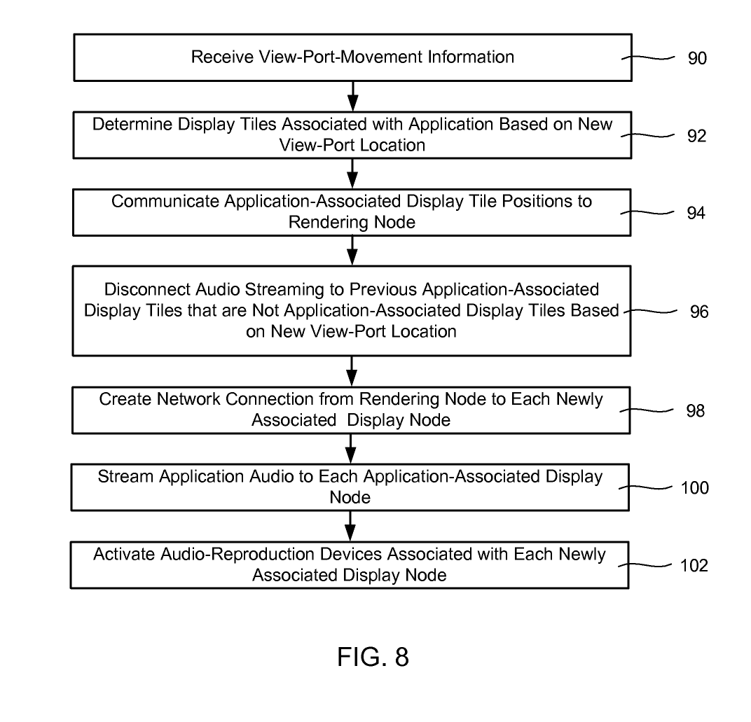

Some embodiments of the present invention may be described in relation to FIG. 5. In these embodiments, a first application view-port associated with a first application may be determined 50 in a display mosaic. One or more display tiles may be associated 51 with the first application based on the first application view-port. These tiles may be referred to as first-application-associated display tiles. The audio-reproduction devices associated with the first-application-associated display tiles may be activated 52. In some embodiments of the present invention, activation of the audio-reproduction devices associated with the first-application-associated display tiles may comprise playing of audio content associated with the first application. A second application view-port associated with a second application may be determined 53 in a display mosaic. One or more display tiles may be associated 54 with the second application based on the second application view-port. These tiles may be referred to as second-application-associated display tiles. The audio-reproduction devices associated with the second-application-associated display tiles may be activated 55. In some embodiments of the present invention, activation of the audio-reproduction devices associated with the second-application-associated display tiles may comprise playing of audio content associated with the second application.

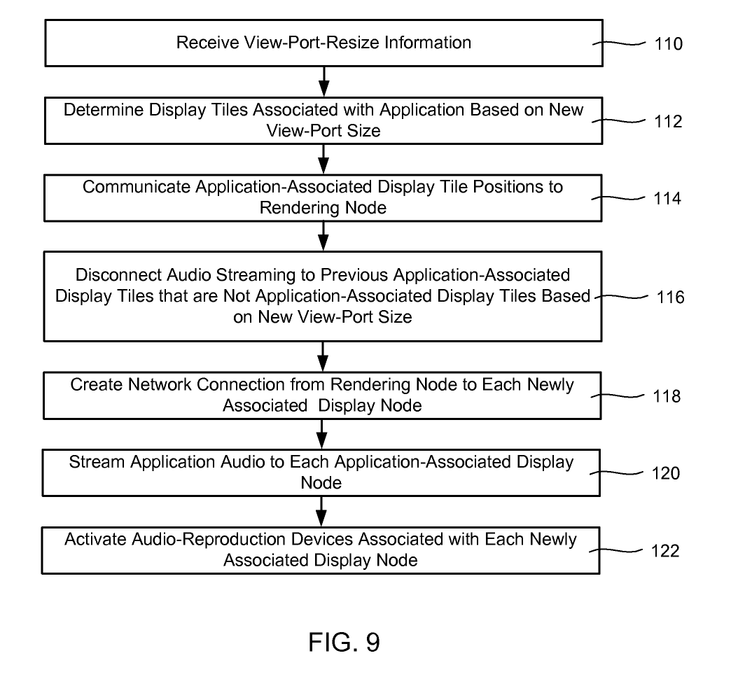

Some embodiments of the present invention may be described in relation to FIG. 6. In these embodiments, in a display mosaic, an application view-port associated with an application may be determined 60. One or more display tiles may be associated 62 with the application based on the application view-port. An audio-reproduction-device parameter may be determined 64, and the audio-reproduction devices associated with the application-associated display tiles may be activated 66 using the audio-reproduction-device parameter.

In some embodiments of the present invention, an audio-reproduction parameter used in activation of an audio-reproduction device may be based on the overlapping area of the application view-port and the display tile associated with the audio-reproduction parameter compared to the area of the display tile associated with the audio-reproduction parameter. In some embodiments, the audio volume for the audio-reproduction device may be scaled in proportion to the area occupied by the view-port on the display tile associated with the audio-reproduction device relative to the area of the view-port.

### Exemplary Embodiment

Some embodiments of the present invention may be understood in relation to the following exemplary embodiments. In these exemplary embodiments of the present invention, a display tile may be associated with a tile identifier (tile ID). For illustration, consider an exemplary tile ID which may be denoted by T(x,y), where, for a display mosaic comprising M×N non-overlapping display tiles arranged as M columns and N rows, x={0, 1, 2, . . . , M−1} and y={0, 1, 2, . . . , N−1}. In one exemplary embodiment, the tile on the lower-left corner of the overall display may have tile ID denoted by T (0,0). Thus, in this exemplary embodiment, the tile ID of the tile on the upper-right corner of overall display may be denoted by T (M−1, N−1).

By way of further illustration and example, the horizontal resolution and the vertical resolution of display tile, T(x,y), may be denoted by W(x,y) pixels and H(x,y) pixels, respectively. In an exemplary embodiment, the horizontal and vertical resolution of each display tile may be the same and may be denoted by W pixels and H pixels, respectively. In this exemplary embodiment, the overall display mosaic comprising M×N tiles has a resolution of MW×NH horizontal by vertical pixels. In this exemplary embodiment, there are no mullions.

A set of one or more audio-reproduction devices, denoted L(x,y), may be associated with display tile T(x,y).

A display mosaic may concurrently run one or more applications which may be denoted A(i), i=0, 1, . . . , Z−1, where Z indicates the number of concurrently running applications. Each application, A(i), may run in its own view-port on the display mosaic. The view-port associated with an application A(i) may be denoted VP(i), i=0, 1, . . . , Z−1. In an exemplary embodiment, consider an application, A(0), running in window VP(0) comprising C×D horizontal and vertical pixels. When the view-port VP(0) is initially placed on the display mosaic such that the bottom-left corner of the view-port is at x, y position of (blx,bly) with respect to the overall display, display tiles associated with application A(0), denoted DT(0), may be determined according to:

$$DT ( 0 ) = \{ T ( j , k ) ∋ j ∈ \{ ⌊ \frac{blx + C}{W} ⌋ , … , ⌈ \frac{blx + C}{W} ⌉ - 1 \} , k ∈ \{ ⌊ \frac{bly}{H} ⌋ , … , ⌈ \frac{bly + D}{H} ⌉ - 1 \} \} ,$$

where └.┘ and ┌.┐ denote floor and ceiling operations, respectively.

In this exemplary embodiment, the audio corresponding to the view-port VP(0) for the application A(0) may be played back from the audio-reproducing devices (for example, loudspeakers) associated with each of the display tiles that the view-port VP(0) occupies. Thus for this exemplary embodiment, the audio-reproduction devices:

$$\{ L ( j , k ) ∋ j ∈ \{ ⌊ \frac{blx}{W} ⌋ , … , ⌈ \frac{blx + C}{W} ⌉ - 1 \} , k ∈ \{ ⌊ \frac{bly}{H} ⌋ , … , ⌈ \frac{bly + D}{H} ⌉ - 1 \} \}$$

may be activated.

In some embodiments of the present invention, each display tile may have a mullion, or border, of t(x,y), b(x,y), r(x,y) and l(x,y) inches, or other measure, on the top-, bottom-, right- and left-side, respectively. These dimensions may correspond to mullions of tp(x,y), bp(x,y), rp(x,y) and lp(x,y) pixel units in size for the top-, bottom-, right-, and left-side, respectively. In some embodiments of the present invention, tp(x,y)=bp(x,y)=a and rp(x,y)=lp(x,y)=b. In these embodiments, a display mosaic comprising M×N tiles has a resolution of M(W+2a)×N(H+2b) horizontal and vertical pixels. Display tiles, DT(0), associated with an application, A(0), running in view-port VP(0) as described above may determined according to:

$$DT ( 0 ) = \{ T ( j , k ) ∋ j ∈ \{ ⌊ \frac{blx}{W + 2 a} ⌋ , … , ⌈ \frac{blx + C}{W + 2 a} ⌉ - 1 \} , k ∈ \{ ⌊ \frac{bly}{H + 2 b} ⌋ , … , ⌈ \frac{bly + D}{H + 2 b} ⌉ - 1 \} \} ,$$

where └.┘ and ┌.┐ denote floor and ceiling operations, respectively.

In this exemplary embodiment, the audio corresponding to the view-port VP(0) for the application A(0) may be played back from the audio-reproducing devices (for example, loudspeakers) associated with each of the display tiles that the view-port VP(0) occupies. Thus for this exemplary embodiment, the audio-reproduction devices:

$$\{ L ( j , k ) ∋ j ∈ \{ ⌊ \frac{blx}{W + 2 a} ⌋ , … , ⌈ \frac{blx + C}{W + 2 a} ⌉ - 1 \} , k ∈ \{ ⌊ \frac{bly}{H + 2 b} ⌋ , … , ⌈ \frac{bly + D}{H + 2 b} ⌉ - 1 \} \}$$

may be activated.

In some embodiments of the present invention, the audio volume for a loudspeaker associated with a display tile may be scaled in proportion to the area occupied on the display tile of the application view-port to the area of the display tile. If V(i) denotes the audio volume associated with application A(i), and an xᵢ-by-yᵢ portion of view-port VP(i) is displayed on display tile T(j,k), where T(j,k)∈DT(i) and the area of T(j,k) is W(j,k) by H(j,k), then in some embodiments, the volume for the loudspeakers, L(j,k), associated with T(j,K) may be set according to:

$${V}_{L ( j , k )} = V ( i ) \frac{{x}_{i} {y}_{i}}{W ( j , k ) H ( j , k )} .$$

In alternative embodiments, the mullion, or border, associated with tile T(j,k) may be considered in the volume determination. In these embodiments, for a horizontal mullion of a and a vertical mullion of b, the volume may be set according to:

$${V}_{L ( j , k )} = V ( i ) \frac{( {x}_{i} + a ) ( {y}_{i} + b )}{( W ( j , k ) + 2 a ) ( H ( j , k ) + 2 b )}$$

when the view-port, VP(i), overlaps one horizontal and one vertical mullion. When the view-port, VP(i), overlaps both horizontal or both vertical, exclusively, mullions, then the volume may be set according to:

$${V}_{L ( j , k )} = V ( i ) \frac{( {x}_{i} + 2 a ) ( {y}_{i} + b )}{( W ( j , k ) + 2 a ) ( H ( j , k ) + 2 b )}$$

$$and$$

$${V}_{L ( j , k )} = V ( i ) \frac{( {x}_{i} + a ) ( {y}_{i} + 2 b )}{( W ( j , k ) + 2 a ) ( H ( j , k ) + 2 b )} ,$$

respectively. When the view-port, VP(i), overlaps both horizontal and both vertical mullions, then the volume may be set according to:

$${V}_{L ( j , k )} = V ( i ) \frac{( {x}_{i} + 2 a ) ( {y}_{i} + 2 b )}{( W ( j , k ) + 2 a ) ( H ( j , k ) + 2 b )} .$$

Some embodiments of the present invention may comprise a Scalable Adaptive Graphics Environment (SAGE) system. Scalable Adaptive Graphics Environment (SAGE) is a graphics-streaming architecture and middleware for enabling data, high-definition video and extremely high-resolution graphics, to be streamed in real-time from distributed rendering and storage clusters to scalable display walls. A SAGE system may comprise of one or more rendering nodes acting as a cluster and one or more display nodes acting as a cluster. A Scalable Adaptive Graphics Environment is described by Jeong, et al., “High-Performance Dynamic Graphics Streaming for Scalable Adaptive Graphics Environment,” Proceedings of SC06, Tampa, Fla., November, 2006, which is hereby incorporated by reference herein in its entirety. A Scalable Adaptive Graphics Environment is described by Renambot, et al., “SAGE: the Scalable Adaptive Graphics Environment,” Proceedings of WACE 2004, Nice, France, September, 2004, which is hereby incorporated by reference herein in its entirety.

In some embodiments of the present invention, one display node may drive one display tile in a display mosaic. In some of these embodiments, the display node identifier (ID) may be denoted based on the corresponding tile ID. In alternative embodiments, a display node may drive more than one display tile in a display mosaic.

### Exemplary SAGE Embodiments

Some embodiments of the present invention may comprise a rendering node which may generate the application data, including the audio data, for an application, which may be denoted A(i). In some embodiments of the present invention, there may be M×N display nodes, denoted D(j,k), each corresponding to a display tile in a display mosaic comprising M×N non-overlapping display tiles arranged as M columns and N rows, x={0, 1, 2, . . . , M−1} and y={0, 1, 2, . . . , N−1}. In some exemplary embodiments, the tile on the lower-left corner of the overall display may have tile ID denoted by T(0,0) and a display node ID denoted by D(0,0). Thus, in these exemplary embodiments, the tile ID of the tile on the upper-right corner of overall display may be denoted by T(M−1, N−1) with associated display node denoted by display node ID D(M−1, N−1).

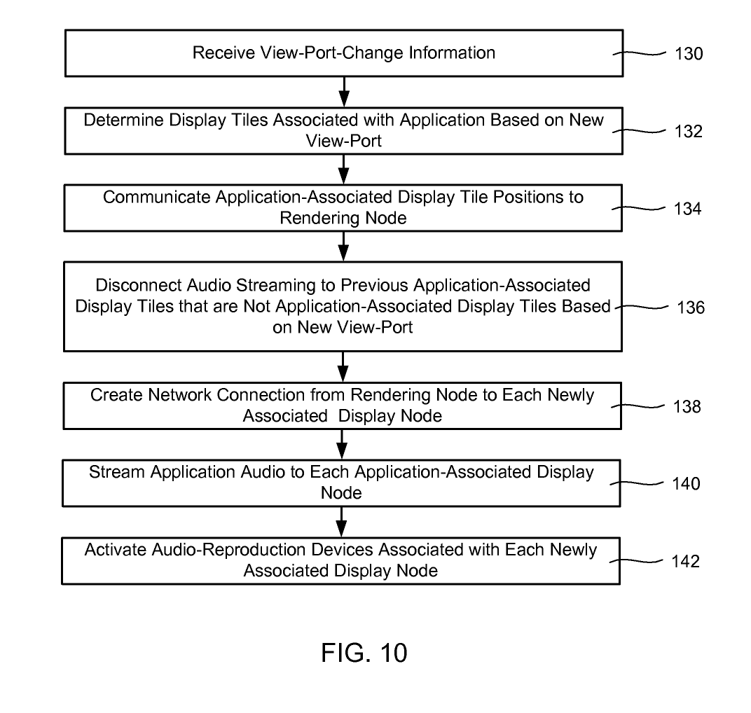

Some embodiments of the present invention maybe described in relation to FIG. 7. In these embodiments, in a display mosaic, an application view-port, VP(i), associated with an application, A(i), may be determined 70. One or more display tiles may be associated 72 with the application based on the application view-port. The display tiles associated 72 with the application may be referred to as application-associated display tiles. In some embodiments of the present invention, the free-space manager of SAGE may do this determination. The SAGE rendering node may split 74 the application image, also considered display data, into sub-images corresponding to each display tile. In some embodiments, there may be a one-to-one correspondence between display nodes and display tiles. The display nodes corresponding to the application-associated display tiles may be referred to as application-associated display nodes. In these embodiments, there would therefore be a one-to-one correspondence between application-associated display tiles and application-associated display nodes. In some embodiments, the free-space manager may communicate the display tile information to the rendering node to accomplish the splitting of the application image.

A network connection from the rendering node to each application-associated display node may be created 76. The audio associated with the application may be streamed 78 to each of the application-associated display nodes. The audio-reproduction devices associated with the application-associated display nodes may be activated 80. In some embodiments, activating an audio-reproduction device may comprise playback of audio content associated with the application.

In some embodiments of the present invention comprising SAGE, a display node may drive exactly one display tile. In these embodiments, the audio-reproduction devices associated with a display node may be the audio-reproduction devices associated with the display tile driven by the display node.

In some of the embodiments of the present invention comprising SAGE, a display node may drive more than one display tile. In these embodiments, the audio-reproduction devices associated with a display node may be the union, or other combination, of the audio-reproduction devices associated with the display tiles driven by the display node.

### View-Port Repositioning

In some embodiments of the present invention, when an application view-port is moved from a first position to a second position in a display mosaic, the audio-reproduction devices associated with the first view-port position may be de-activated, and the audio-reproduction devices associated with the new (second) view-port position may be activated.

For example, when a view-port VP(i), corresponding to an application, A(i), is moved from an initial position of (blx,bly) with respect to the overall display to a new position of (nblx,nbly) with respect to the overall display, new display tiles associated with application A(i), denoted nDT(i), may be determined according to:

$$nDT ( i ) = \{ T ( j , k ) ∋ j ∈ \{ ⌊ \frac{nblx}{W} ] , … , ⌈ \frac{nblx + C}{W} ⌉ - 1 \} , k ∈ \{ ⌊ \frac{nbly}{H} ⌋ , … , ⌈ \frac{nbly + D}{H} ⌉ - 1 \} \} ,$$

when view-port VP(i) comprises C×D horizontal and vertical pixels in a display mosaic comprising M×N non-overlapping display tiles arranged as M columns and N rows with no mullions.

In this exemplary embodiment, the audio corresponding to the view-port VP(i) for the application A(i) may be played back from the audio-reproducing devices (for example, loudspeakers) associated with each of the display tiles that the view-port VP(i) now occupies. Thus for this exemplary embodiment, the audio-reproduction devices:

$$\{ L ( j , k ) ∋ j ∈ \{ ⌊ \frac{nblx}{W} ⌋ , … , ⌈ \frac{nblx + C}{W} ⌉ - 1 \} , k ∈ \{ ⌊ \frac{nbly}{H} ⌋ , … , ⌈ \frac{nbly + D}{H} ⌉ - 1 \} \}$$

may be activated. In some embodiments of the present invention, those display tiles previously associated with the application at the first view-port location which are not associated with the application at the new view-port location may be deactivated.

In some embodiments of the present invention, each display tile may have a mullion, or border, of t(x,y), b(x,y), r(x,y) and l(x,y) inches, or other measure, on the top-, bottom-, right- and left-side, respectively. These dimensions may correspond to mullions of tp(x,y), bp(x,y), rp(x,y) and lp(x,y) pixel units in size for the top-, bottom-, right-, and left-side, respectively. In some embodiments of the present invention, tp(x,y)=bp(x,y)=a and rp(x,y)=lp(x,y)=b. In these embodiments, a display mosaic comprising M×N tiles has a resolution of M(W+2a)×N(H+2b) horizontal and vertical pixels. Display tiles for a view-port repositioned from (blx,bly) to (nblx,nbly), nDT(i), associated with an application, A(i), running in view-port VP(i) as described above may be determined according to:

$$nDT ( i ) = \{ T ( j , k ) ∋ j ∈ \{ ⌊ \frac{nblx}{W + 2 a} ⌋ , … , ⌈ \frac{nblx + C}{W + 2 a} ⌉ - 1 \} , k ∈ \{ ⌊ \frac{nbly}{H + 2 b} ⌋ , … , ⌈ \frac{nbly + D}{H + 2 b} ⌉ - 1 \} \} .$$

In this exemplary embodiment, the audio corresponding to the view-port VP(i) for the application A(i) may be played back from the audio-reproducing devices (for example, loudspeakers) associated with each of the display tiles that the view-port VP(i) occupies. Thus for this exemplary embodiment, the audio-reproduction devices:

$$\{ L ( j , k ) ∋ j ∈ \{ ⌊ \frac{nblx}{W + 2 a} ⌋ , … , ⌈ \frac{nblx + C}{W + 2 a} ⌉ - 1 \} , k ∈ \{ ⌊ \frac{nbly}{H + 2 b} ⌋ , … , ⌈ \frac{nbly + D}{H + 2 b} ⌉ - 1 \} \}$$

may be activated. In some embodiments of the present invention, those display tiles previously associated with the application at the first view-port location which are not associated with the application at the new view-port location may be deactivated.

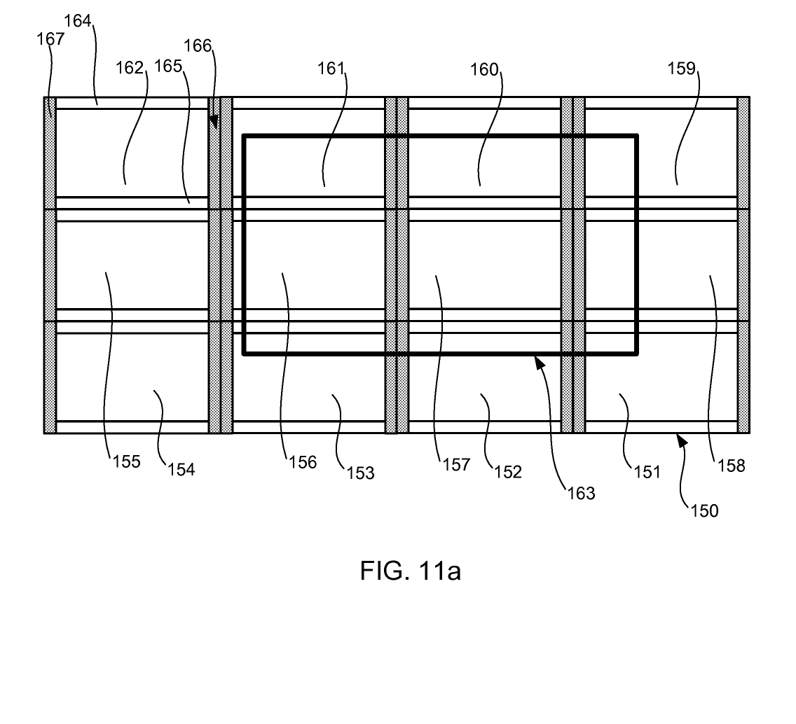

Some embodiments of the present invention comprising SAGE may be described in relation to FIG. 8. When a view-port is repositioned, the free-space manager in SAGE may receive 90 information about the repositioning of the view-port. In some embodiments, this information may be sent from a user-interface client to the free-space manager. The free-space manager may then determine 92 new display tile overlap positions with the new view-port, thereby associating a new group of display tiles with the application associated with the view-port. The free-space manager may communicate 94 the new display tiles to the SAGE rendering node. The rendering node may disconnect 96 those display tiles that were associated with the application at the previous view-port location but which are not associated with the application at the new view-port location. The rendering node may establish 98 a connection with each of the associated display nodes. The rendering node may initiate 100 new audio streaming and activate 102 the audio-reproduction devices associated with the newly associated display nodes.

### View-Port Resizing

In some embodiments of the present invention, when an application view-port is resized from a first size to a second size, the audio-reproduction devices associated with the first view-port may be de-activated, and the audio-reproduction devices associated with the newly sized view-port may be activated.

In some embodiments of the present invention, when a view-port, VP(i), located with bottom-left corner at (blx, bly), comprising C×D horizontal and vertical pixels in a display mosaic comprising M×N non-overlapping display tiles arranged as M columns and N rows with no mullions is resized by a factor of a in the horizontal direction and β in the vertical direction without repositioning the bottom-left corner, then new display tiles associated with application A(i), denoted nDT(i), may be determined according to:

$$nDT ( i ) = \{ T ( j , k ) ∋ j ∈ \{ ⌊ \frac{blx}{W} ⌋ , … , ⌈ \frac{blx + α C}{W} ⌉ - 1 \} , k ∈ \{ ⌊ \frac{bly}{H} ⌋ , … , ⌈ \frac{bly + β D}{H} ⌉ - 1 \} \} .$$

In this exemplary embodiment, the audio corresponding to the view-port VP(i) for the application A(i) may be played back from the audio-reproducing devices (for example, loudspeakers) associated with each of the display tiles that the newly sized view-port VP(i) now occupies. Thus for this exemplary embodiment, the audio-reproduction devices:

$$\{ L ( j , k ) ∋ j ∈ \{ ⌊ \frac{blx}{W} ⌋ , … , ⌈ \frac{blx + α C}{W} ⌉ - 1 \} , k ∈ \{ ⌊ \frac{bly}{H} ⌋ , … , ⌈ \frac{bly + β D}{H} ⌉ - 1 \} \}$$

may be activated. In some embodiments of the present invention, those display tiles previously associated with the application with the view-port of the first size which are not associated with the application at the new view-port size may be deactivated.

In some embodiments of the present invention, each display tile may have a mullion, or border, of t(x,y), b(x,y), r(x,y) and l(x,y) inches, or other measure, on the top-, bottom-, right- and left-side, respectively. These dimensions may correspond to mullions of tp(x,y), bp(x,y), rp(x,y) and lp(x,y) pixel units in size for the top-, bottom-, right-, and left-side, respectively. In some embodiments of the present invention, tp(x,y)=bp(x,y)=a and rp(x,y)=lp(x,y)=b. In these embodiments, a display mosaic comprising M×N tiles has a resolution of M(W+2a)×N(H+2b) horizontal and vertical pixels. Display tiles for a view-port positioned at (blx,bly) and resized by a factor of a in the horizontal direction and β in the vertical direction, nDT(i), associated with an application, A(i), running in view-port VP(i) as described above may be determined according to:

$$nDT ( i ) = \{ T ( j , k ) ∋ j ∈ \{ ⌊ \frac{blx}{W + 2 b} ⌋ , … , ⌈ \frac{blx + α C}{W + 2 b} ⌉ - 1 \} , k ∈ \{ ⌊ \frac{bly}{H + 2 b} ⌋ , … , ⌈ \frac{bly + β D}{H + 2 b} ⌉ - 1 \} \} .$$

In this exemplary embodiment, the audio corresponding to the view-port VP(i) for the application A(i) may be played back from the audio-reproducing devices (for example, loudspeakers) associated with each of the display tiles that the view-port VP(i) occupies. Thus for this exemplary embodiment, the audio-reproduction devices:

$$\{ L ( j , k ) ∋ j ∈ \{ ⌊ \frac{blx}{W + 2 b} ⌋ , … , ⌈ \frac{blx + α C}{W + 2 b} ⌉ - 1 \} , k ∈ \{ ⌊ \frac{bly}{H + 2 b} ⌋ , … , ⌈ \frac{bly + β D}{H + 2 b} ⌉ - 1 \} \}$$

may be activated. In some embodiments of the present invention, those display tiles previously associated with the application with the view-port of the first size which are not associated with the application at the new view-port size may be deactivated.

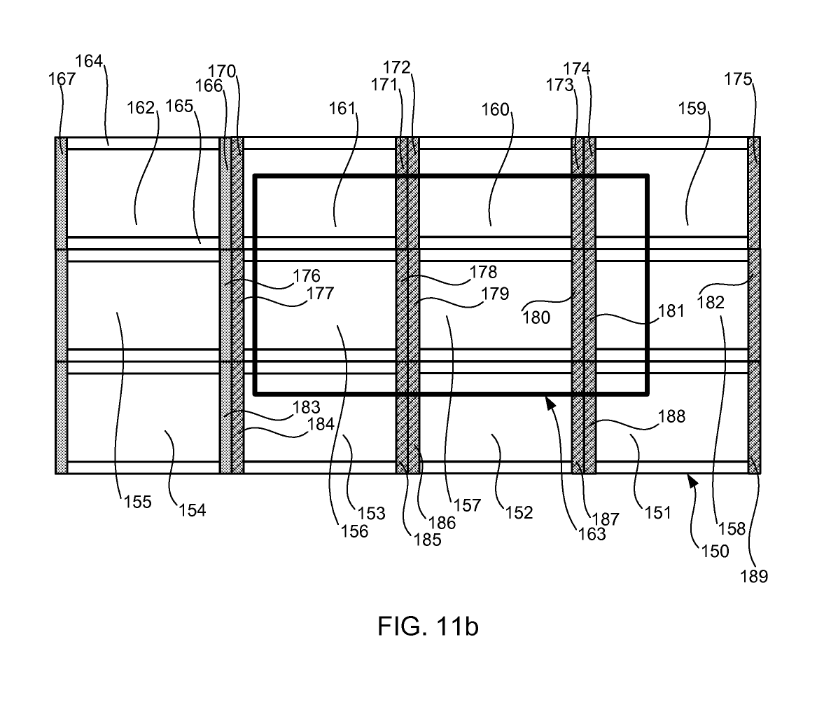

Some embodiments of the present invention comprising SAGE may be described in relation to FIG. 9. When a view-port is resized, the free-space manager in SAGE may receive 110 information about the changed size of the view-port. In some embodiments, this information may be sent from a user-interface client to the free-space manager. The free-space manager may then determine 112 new display tile overlap positions with the newly sized view-port, thereby associating a new group of display tiles with the application associated with the view-port. The free-space manager may communicate 114 the new display tiles to the rendering node. The rendering node may disconnect 116 those display tiles that were associated with the application at the previously sized view-port but which are not associated with the application at the new view-port size. The rendering node may establish 118 a connection with each of the associated display nodes. The rendering node may initiate 120 new audio streaming and activate 122 the audio-reproduction devices associated with the newly associated display nodes.

### View-Port Resizing and Repositioning

In some embodiments of the present invention, when a view-port is both resized and repositioned, the audio-reproduction devices associated with the first view-port may be de-activated, and the audio-reproduction devices associated with the newly sized, repositioned view-port may be activated.

In some embodiments of the present invention, when a view-port, VP(i), located initially with bottom-left corner at (blx,bly), comprising C×D horizontal and vertical pixels in a display mosaic comprising M×N non-overlapping display tiles arranged as M columns and N rows with no mullions is resized by a factor of α in the horizontal direction and β in the vertical direction and repositioned with bottom-left corner at (nblx,nbly), then new display tiles associated with application A(i), denoted nDT(i), may be determined according to:

$$nDT ( i ) = \{ T ( j , k ) ∋ j ∈ \{ ⌊ \frac{nblx}{W} ⌋ , … , ⌈ \frac{nblx + α C}{W} ⌉ - 1 \} , k ∈ \{ ⌊ \frac{nbly}{H} ⌋ , … , ⌈ \frac{nbly + β D}{H} ⌉ - 1 \} \} .$$

In this exemplary embodiment, the audio corresponding to the view-port VP(i) for the application A(i) may be played back from the audio-reproducing devices (for example, loudspeakers) associated with each of the display tiles that the newly positioned, newly sized view-port VP(i) now occupies. Thus for this exemplary embodiment, the audio-reproduction devices:

$$\{ L ( j , k ) ∋ j ∈ \{ ⌊ \frac{nblx}{W} ⌋ , … , ⌈ \frac{nblx + α C}{W} ⌉ - 1 \} , k ∈ \{ ⌊ \frac{nbly}{H} ⌋ , … , ⌈ \frac{nbly + β D}{H} ⌉ - 1 \} \}$$

may be activated. In some embodiments of the present invention, those display tiles previously associated with the application with the initial view-port which are not associated with the application at the new view-port may be deactivated.

In some embodiments of the present invention, each display tile may have a mullion, or border, of t(x,y), b(x,y), r(x,y) and l(x,y) inches, or other measure, on the top-, bottom-, right- and left-side, respectively. These dimensions may correspond to mullions of tp(x,y), bp(x,y), rp(x,y) and lp(x,y) pixel units in size for the top-, bottom-, right-, and left-side, respectively. In some embodiments of the present invention, tp(x,y)=bp(x,y)=a and rp(x,y)=lp(x,y)=b. In these embodiments, a display mosaic comprising M×N tiles has a resolution of M(W+2a)×N(H+2b) horizontal and vertical pixels. Display tiles for a view-port positioned at initial position (blx,bly) and moved to position (nblx,nbly) and resized by a factor of α in the horizontal direction and β in the vertical direction, nDT(i), associated with an application, A(i), running in view-port VP(i) as described above may determined according to:

$$nDT ( i ) = \{ T ( j , k ) ∋ j ∈ \{ ⌊ \frac{nblx}{W + 2 a} ⌋ , … , ⌈ \frac{nblx + α C}{W + 2 a} ⌉ - 1 \} , k ∈ \{ ⌊ \frac{nbly}{H + 2 b} ⌋ , … , ⌈ \frac{nbly + β D}{H + 2 b} ⌉ - 1 \} \} .$$

In this exemplary embodiment, the audio corresponding to the view-port VP(i) for the application A(i) may be played back from the audio-reproducing devices (for example, loudspeakers) associated with each of the display tiles that the view-port VP(i) occupies. Thus for this exemplary embodiment, the audio-reproduction devices:

$$\{ L ( j , k ) ∋ j ∈ \{ ⌊ \frac{nblx}{W + 2 a} ⌋ , … , ⌈ \frac{nblx + α C}{W + 2 a} ⌉ - 1 \} , k ∈ \{ ⌊ \frac{nbly}{H + 2 b} ⌋ , … , ⌈ \frac{nbly + β D}{H + 2 b} ⌉ - 1 \} \}$$

may be activated. In some embodiments of the present invention, those display tiles previously associated with the application with the initial view-port which are not associated with the application with the new view-port may be deactivated.

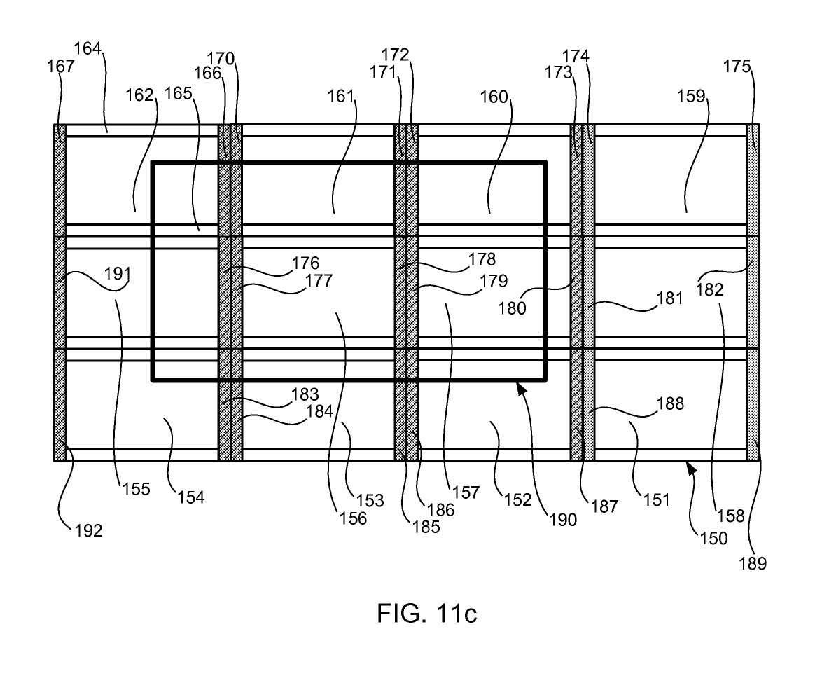

Some embodiments of the present invention comprising SAGE may be described in relation to FIG. 10. When a view-port is resized and repositioned, the free-space manager in SAGE may receive 130 information about the size and location of the new view-port. In some embodiments, this information may be sent from a user-interface client to the free-space manager. The free-space manager may then determine 132 new display tile overlap positions with the newly sized, repositioned view-port, thereby associating a new group of display tiles with the application associated with the view-port. The free-space manager may communicate 134 the new display tiles to the rendering node. The rendering node may disconnect 136 those display tiles that were associated with the application at the previously sized, previously located view-port but which are not associated with the application at the new view-port. The rendering node may establish 138 a connection with each of the associated display nodes. The rendering node may initiate 140 new audio streaming and activate 142 the audio-reproduction devices associated with the newly associated display nodes.

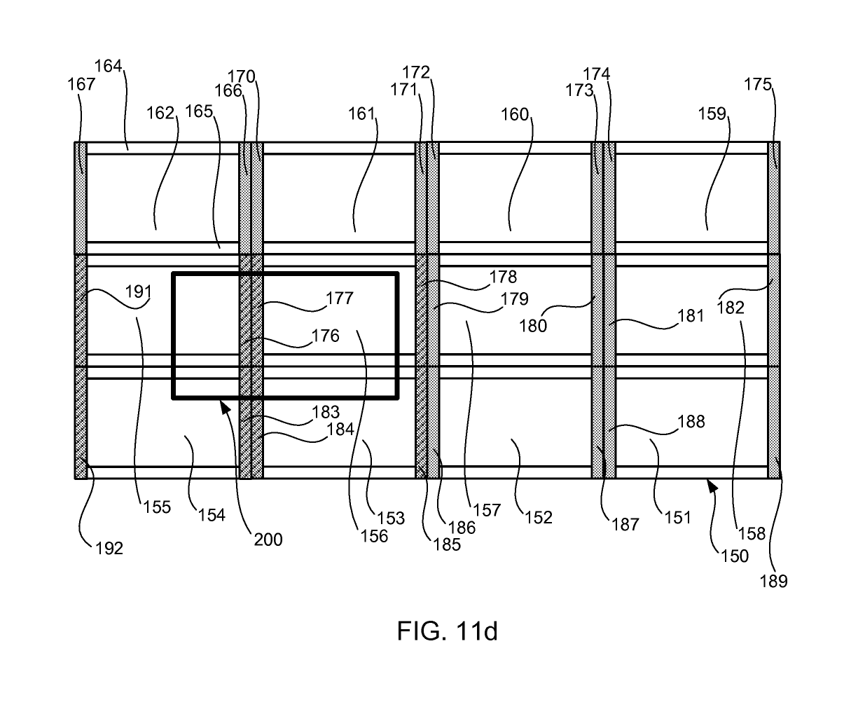

An exemplary embodiment of the present invention may be described in relation to FIG. 11. FIG. 11a depicts a display mosaic 150 comprising twelve display tiles 151-162. Each display tile 151-162 comprises a left, right, top and bottom border, or mullion. The borders 164-167 have been shown labeled for the upper-left display tile 162. The left border (shown labeled 167 for display tile 162) and the right border (shown labeled 166 for display tile 162) for each display tile 151-162 each comprise an audio-reproduction device which may be associated with the display tile for which it borders. The audio-reproduction devices are indicated in FIG. 11a in light gray. For example, the audio-reproduction devices associated with the upper-left display tile 162 are in the left border 167 and right border 166 of the display tile 162. An exemplary view-port 163 is depicted on the display mosaic 150. The view-port 163 may be associated with a first application for which display data is being displayed on the overlapping display tiles 151, 152, 153, 156-161. In some embodiments of the present invention, all overlapping display tiles 151, 152, 153, 156-161 may be considered application-associated display tiles for the view-port 163. FIG. 11b depicts the activated audio-reproduction devices 170-175, 177-182, 183-189 in gray cross-hatching for the view-port 163 for embodiments of the present invention in which all overlapping display tiles 151, 152, 153, 156-161 may be considered application-associated display tiles. The activated audio-reproduction devices 170-175, 177-182, 183-189 for these embodiments may be the audio-reproduction devices associated with the application-associated display tiles.

In alternative embodiments of the present invention, an overlapping display tile may not be considered an application-associated display tile if it does not sufficiently overlap the view-port 163. In some embodiments of the present invention, for example, the lower-right display tile 151 may not be considered an application-associated display tile based on the area of overlap with the view-port 163. In these embodiments, the audio-reproduction devices 188, 189 associated with the lower-right display tile 151 may not be activated.

In some embodiments of the present invention, when a new view-port 190 is generated by repositioning the view-port 163 to a new location as depicted in FIG. 11c, the application-active display tiles may change to those display tiles 152-157, 160, 161, 162 that overlap the new view-port 190. In these embodiments, the audio-reproduction devices 174, 175, 181, 182, 188, 189 associated with display tiles 151, 158, 159 which are no longer application-associated display tiles may be deactivated. While display tiles 154, 155, 162 which newly overlap the new view-port 190 may now be considered application-associated display tiles 152-157, 160, 161, 162. The audio-reproduction devices 166, 167, 176, 183, 191, 192 associated with the new application-associated display tiles 154, 155, 162 may now be activated.

In some embodiments of the present invention, when a new view-port 200 is generated by resizing the view-port 190 as depicted in FIG. 11d, the application-active display tiles may change to those display tiles 153-156 that overlap the new view-port 200. In these embodiments, the audio-reproduction devices 166, 167, 170, 171, 172, 173, 179, 180, 186, 187 associated with display tiles 152 157,160, 161, 162 which are no longer application-associated display tiles may be deactivated.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for activating an audio device associated with a display, said method comprising:
a) determining an initial first application view-port in a display mosaic comprising a first plurality of display tiles, wherein said initial first application view-port is associated with a first application;
b) associating a first display tile from said first plurality of display tiles with said first application based on said initial first application view-port; and
c) activating a first audio device, wherein said first audio device is associated with said first display tile.

2. A method as described in claim 1, said method further comprising:
a) determining an updated first application view-port in said display mosaic, wherein said updated first application view-port is associated with said first application; and
b) deactivating said first audio device when said first display tile is not associated with said updated first application view-port.

3. A method as described in claim 1, said method further comprising:
a) associating, with said first application, a second plurality of display tiles from said first plurality of display tiles, wherein said second plurality of display tiles comprises said first display tile and all display tiles in said first plurality of display tiles which substantially overlap said initial first application view-port; and
b) activating a plurality of audio devices, wherein said plurality of audio devices comprises all audio devices associated with said second plurality of display tiles.

4. A method as described in claim 1, said method further comprising:
a) determining a second application view-port in said display mosaic, wherein said second application view-port is associated with a second application;
b) associating a second display tile from said first plurality of display tiles with said second application based on said second application view-port;
c) activating a second audio device, wherein said second audio device is associated with said second display tile; and
d) wherein:
i) said activating said first audio device comprises playing audio content associated with said first application; and
ii) said activating said second audio device comprises playing audio content associated with said second application.

5. A method as described in claim 1, wherein:
a) a Scalable Adaptive Graphics Environment (SAGE) display node is associated with said first display tile; and
b) said activating said first audio device comprises streaming audio content associated with said first application to said SAGE display node.

6. A method as described in claim 1, wherein said display mosaic comprises a single display device.

7. A method as described in claim 1, wherein said display mosaic comprises a plurality of display devices.

8. A method as described in claim 1, wherein each of said display tiles in said first plurality of display tiles comprises a display device.

9. A method as described in claim 1, wherein said activating comprises playing audio content associated with said first application.

10. A method as described in claim 1, wherein said first audio device is integral to said first display tile.

11. A method as described in claim 1, said method further comprising determining a first activation parameter associated with said first audio device, wherein said first activation parameter is related to the area of said first display tile and the area of said initial first application view-port.

12. A method as described in claim 11, wherein said first activation parameter is audio volume.

13. A method as described in claim 1, wherein:
a) said first application comprises first application display data; and
b) said determining an initial first application view-port comprises identifying any of said first plurality of display tiles in which said first application display data is displayed.

14. A method for providing application audio, said method comprising:
a) partitioning a display mosaic into a first plurality of display tiles;
b) associating at least one audio device with each display tile in said first plurality of display tiles;
c) determining a second plurality of display tiles from said first plurality of display tiles, wherein said second plurality of display tiles are associated with a first application; and
d) activating said at least one audio device associated with each display tile in said second plurality of display tiles.

15. A method as described in claim 14, wherein said activating comprises playing audio content associated with said first application.

16. A method as described in claim 14, said method further comprising determining a first activation parameter associated with said first application.

17. A method as described in claim 16, wherein said first activation parameter is audio volume.

18. A method as described in claim 14, said method further comprising:
a) determining a third plurality of display tiles from said first plurality of display tiles, wherein said third plurality of display tiles are associated with a second application;
b) activating said at least one audio device associated with each display tile in said third plurality of display tiles; and
c) wherein:
i) said activating said at least one audio device associated with each display tile in said second plurality of display tiles comprises playing audio content associated with said first application; and
ii) said activating said at least one audio device associated with each display tile in said third plurality of display tiles comprises playing audio content associated with said second application.

19. A method as described in claim 14, wherein a first audio device is integral to a first display tile from said first plurality of display tiles.

20. A method as described in claim 14, wherein said display mosaic comprises a single display device.

21. A system for providing application audio, said system comprising:
a) a display mosaic, said display mosaic comprising a first plurality of display tiles;
b) a plurality of audio devices, wherein each of said plurality of audio device is associated with at least one of said display tiles in said first plurality of display tiles;
c) an application-view-port identifier for identifying an application view-port on said display mosaic, wherein said application view-port is associated with an application;
d) a display-tile associator for associating an application display tile from said first plurality of display tiles with said application based on said application view-port; and
e) an audio-device activator for activating at least one of said at least one audio devices associated with said application display.

22. A system as described in claim 21, wherein said display mosaic comprises a single display device.

23. A system as described in claim 21, wherein said display mosaic comprises a plurality of display devices.
